(19) United States
(12) Patent Application Publication
(10) Pub. No.: US 2015/0371153 A1
(43) Pub. Date: Dec. 24, 2015

(54) Vehicle Sharing System Supporting Nested Vehicle Sharing Within A Loan Period For A Primary Vehicle Borrower

(71) Applicant: General Motors LLC, Detroit, MI (US)

(72) Inventors: David A. Lohmeier, Clarkston, MI (US); Dexter C. Lowe, Sterling Heights, MI (US); Esteban Camacho, Belleville, MI (US); Shpetim S. Veliu, Livonia, MI (US)

(21) Appl. No.: 14/313,655

(22) Filed: Jun. 24, 2014

(51) Int. Cl. G06Q 10/02; G06Q 30/06

(52) U.S. Cl. CPC G06Q 10/02; G06Q 30/0645; G06Q 40/08; G06Q 40/025

(57) ABSTRACT

A system and method are described for managing nested sharing of vehicles. A shared vehicle server registers, in a shared vehicle database, a primary reservation by a primary borrower for a shared vehicle, that specifies a primary time period. The server receives an indication that the shared vehicle is to be made available for nested sharing during a portion of the primary time period. The server creates a nested sharing availability record, for the shared vehicle, that specifies a sub-period of the primary time period. The shared vehicle server matches the nested sharing availability record to a shared vehicle request for a secondary borrower. The shared vehicle server registers, in the vehicle database, a secondary reservation by the secondary borrower for the shared vehicle that specifies a secondary time period within the sub-period. The server tracks status of the shared vehicle during the secondary time period.

### FIELD

The present disclosure relates generally to telematics systems and more particularly to systems and associated telematics services provided by a communications center communicatively coupled to installed telematics units via mobile wireless network connections. More particularly, the present disclosure is directed to a centrally managed vehicle sharing system that supports nesting a secondary sharing, between a primary borrower of the vehicle and a secondary borrower, during a sub-period within a loan period during which the vehicle is assigned to the primary borrower.

### BACKGROUND

Telematics units within mobile vehicles provide subscribers with connectivity to a telematics service provider (TSP). The TSP provides subscribers with an array of services ranging from emergency call handling and stolen vehicle recovery to vehicle system status and diagnostics monitoring, global navigation system aided position identification, map services, and turn-by-turn navigation assistance. Telematics units are often provisioned and activated at a point of sale when a subscriber purchases a telematics-equipped vehicle. Upon activation, the telematics unit can be utilized to directly/indirectly provide subscribers/users with a variety of telematics-facilitated services such as those described herein.

Methods of vehicle time sharing have developed in recent years in response to increased opportunities for monetizing the idle capacity of unused vehicles. Automobile rental services have targeted, for example, locations where the costs of owning and storing a vehicle are high relative to potential owners' available cash flows and where potential owners are likely to use vehicles for only a small percentage of the total available time. Meanwhile, more traditional automobile rental business models, such as those that maintain large vehicle fleets in the vicinity of airports to cater to business travelers and vacationers, have remained successful. Moreover, it may be desirable in a rideshare environment for a vehicle owner/lender to seek out qualified/available borrowers as a source of supplemental income. Thus, the more opportunities provided for others to borrow the vehicle, the greater the potential income available to the vehicle owner/lender.

Automobile rental services and other automobile owners who intend to rent, loan or share their automobiles with other drivers may maintain accounts linking the telematics units with TSPs to preserve the functionality of telematics units for their customers and/or share groups. Moreover, in the context of automobile rentals and rideshare groups, an element of mutual trust/confidence is needed with regard to both owners and drivers. From an automobile owner perspective, there is a desire to ensure that renters, borrowers and/or rideshare users do not abuse, misuse or otherwise subject a vehicle to harmful uses and/or actual damage. If a particular user has a driving style that is more likely to lead to vehicle damage or unusual wear/tear—even if considered safe, it is in the vehicle owner/shareholder's best interest to deny such user access to the vehicle or at least require use at a higher cost. From a user perspective, there is a desire to ensure that the vehicle that they use has been properly used/maintained and is in good working order. A perspective user could decline rental or partial ownership/liability for a poorly maintained or damaged rental/shared vehicle. Furthermore, users could benefit from receiving objective feedback regarding their driving habits measured against standards established from observing the driving behavior of thousands of other drivers. The same can be said for vehicle owners with regard to the quality of maintenance and proper use of particular vehicles.

Known systems acquire and process a variety of vehicle sensor and GPS information to render secondary information. However, such systems, including for example the one described in McMillan et al., U.S. Pat. No. 6,064,970, focus upon identifying/analyzing/characterizing driver behavior for the purpose of providing a driver/vehicle safety analysis and rating—and ultimately provide an insurance discount and/or surcharge in view of observed actions during a prior billing period. In other words, the driver's actions are monitored during an insurance billing period. The actions are analyzed to render a penalty/reward at the end of the insurance billing period. Such characteristics include how, when, where a user operates a vehicle. The resulting processing of such information establishes a driver rating based upon the likelihood that the driver will be involved in an incident for which an insurance claim will arise.

The above body of information is provided for the convenience of the reader. The foregoing describes a suitable environment for which the described system and method are provided, and is not an attempt to review or catalog the prior art.

### BRIEF SUMMARY

A method, computer readable medium and system are described for managing nested sharing of vehicles in the system including a shared vehicle server and a shared vehicle database. The shared vehicle server is configured to execute the method including operations including registering in the shared vehicle database a primary reservation by a primary borrower for a shared vehicle, the primary reservation specifying a primary time period. The server is configured to receive an indication, after the registering, that the shared vehicle is to be made available for nested sharing during a portion of the primary time period.

The shared vehicle server creates a nested sharing availability record for the shared vehicle in response to receiving the indication. The nested sharing availability record specifies a sub-period of the primary time period. The shared vehicle server matches, after creating the nested sharing availability record, the nested sharing availability record to a shared vehicle request for a secondary borrower. The shared vehicle server registers, in the vehicle database, a secondary reservation by the secondary borrower for the shared vehicle. The secondary reservation specifies a secondary time period within the sub-period. Thereafter, the shared vehicle server tracks status of the shared vehicle during the secondary time period. The tracking information obtained during the tracking includes at least a vehicle location.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2A is an exemplary set of parameters for which values are acquired and provided by the telematics units during operation of a rental/shared vehicle for storage in tables maintained by a database containing driver and vehicle ratings related data for purposes of generating driver and vehicle ratings in a rental/shared vehicle environment;

FIG. 2B is an exemplary set of vehicle status parameters maintained, for an identified vehicle, in a centralized database supporting administration of vehicle selection, brokering, and tracking during nested vehicle sharing;

FIG. 3A is an exemplary set of data fields in a message provided by the telematics unit containing vehicle usage information for storage in the database;

FIG. 3B is an exemplary set of data fields in a message provided by the telematics unit containing vehicle location status information for determining availability information in real time and issue appropriate notifications to interested parties;

FIG. 4A identifies fields of a vehicle driver record containing information acquired and used by the system in the course of matching driver requests to available vehicles;

FIG. 4B identifies fields of a data structure maintained by the system for processing a shared vehicle request by an identified driver;

FIG. 4C identifies fields of a data structure maintained by the system to identify a vehicle and associated current status and availability for borrowing;

FIG. 4D identifies fields of an exemplary vehicle availability record;

FIG. 4E identifies fields of a vehicle reservation record;

FIG. 5 is a flowchart illustrating a process for updating the centralized shared vehicle table with new availability information;

FIG. 6 is a flowchart illustrating a process implemented on a ratings and vehicle sharing server to render a list of rated available vehicles in response to a request from a rated user specifying a vehicle rating level and period of use; and

FIG. 7 is a schematic diagram depicting a sequence of activities carried out by a vehicle owner, primary borrower and secondary borrower in accordance with an exemplary nested ride share arrangement.

### DETAILED DESCRIPTION OF THE DRAWINGS

Before discussing the details of the invention and the environment wherein the invention may be used, a brief overview is given to guide the reader. In general terms, not intended to limit the claims, a system and method are described herein for maintaining a database and ratings system for multi-user (e.g., rental, shared, etc.) vehicles and drivers. The vehicles transmit a variety of sensor-based measurements over-the-air for storage in a multi-user vehicle use database via mobile wireless communications devices integrated with/within telematics units installed on the vehicles. The users, including both vehicle owners and borrowers, indicate on a real time basis availability of multi-user vehicles currently in their possession. The real time vehicle availability information includes both a current location of the vehicle and a period of time the vehicle is available for use at the current location.

A ratings engine associated with the multi-user vehicle use database, accessed by users for example via the Internet, enables drivers (e.g., renters) and owners (e.g., rental companies) to query the rideshare database to render a variety of ratings information for particular drivers and/or vehicles for which information was previously stored/tabled in the rideshare database.

In the present system and method, criteria applied to information maintained by the multi-user vehicle use database—information previously provided by telematics units relating to drivers and vehicles—to render a rating, fundamentally differs from criteria applied by insurers to assess a claim risk for a potential or current insured. The system and method described herein facilitate rating: (1) a current operational health of an identified vehicle, and (2) a foreseeable impact that use of vehicles by a particular user will have upon the operational health of the vehicles.

Moreover, the vehicle records/entries of the multi-user vehicle use database include vehicle availability information for particular identified vehicles. Such vehicle availability information includes both: (1) an availability period and (2) a geographic location associated with a commencement/completion of the indicated availability period (i.e., the vehicle pick-up/drop off location(s)). The additional real time availability information presents an opportunity for a primary borrower of an identified vehicle to offer the identified vehicle for use during a sub-period of inactivity for the primary borrower's period of use. Such use by primary and secondary borrowers, during the primary borrower's period of use, is referred herein to as “nested vehicle sharing.” Nested vehicle sharing exploits substantial idle time within the primary borrower's period to meet transportation needs of a secondary borrower located in the vicinity of the currently parked/unused vehicle.

Renters/users of a rental/shared vehicle seek assurance that the vehicle will operate properly during use. Renters/sharers of a rental/shared vehicle seek assurance that the vehicle will be used/maintained in a manner that ensures good long-term health of the vehicle. Both of these aims can be met by the described system and method using criteria that do not necessitate determining the likelihood that the vehicle will be involved in an event for which an insurance claim will arise and the magnitude of such claim. In this way, the described system and method fundamentally differ from the prior systems that apply criteria to measurements and events acquired during vehicle operation to rate, reward and/or penalize users based upon recorded instances of driving behavior that impact a likelihood that a particular driver's driving behavior will lead to an insurance claim. The presence of user ratings enables a car owner/lender to ensure that a primary borrower only allows a suitable/desirable secondary borrower to nest vehicle sharing. For example, the car owner/lender may specify a particular rating requirement/threshold for any secondary borrow (a rating level that may in fact differ from a rating requirement for a primary borrower).

The above-described system facilitates providing a vehicle sharing management system that supports “nested vehicle sharing” within a loan period between primary and secondary vehicle borrowers. Such nested vehicle sharing potentially facilitates greater availability and usage of a shared vehicle by allowing the shared vehicle to be used by the secondary borrower during a sub-period of a period to which the shared vehicle is assigned to the primary borrower—with pickup/drop-off points to be negotiated between the primary and secondary borrows.

The system and processes described herein leverage the functionality of the telematics units on shared vehicles to actively report vehicle location to ensure timely return of a shared vehicle by a current borrow to avoid adversely impacting reservations of subsequent borrows/lenders of the shared vehicle. The system and resulting processes described herein relate primarily to shared vehicle reservation functionality—as opposed to an active shared vehicle agreement enforcement functionality. Thus, rather than actively re-possessing a shared vehicle at the end of a borrowing period, the system may issue a warning/alert message (based upon a reported current location of the shared vehicle) to a current borrower of an impending/actual violation of an agreement to return the vehicle to a current lender at a specified time and place. Furthermore, to the extent that the agreement violation impacts a lender and/or subsequent borrower of the shared vehicle, a message may be issued by the system to the impacted lender and/or subsequent borrower (including additional informative data including an adjusted estimated time of arrival at the agreed location). In the case of a subsequent borrower having a borrowing period start impacted by a late vehicle return, the system may issue a message inviting the subsequent borrower to re-book the impacted reservation. Such “late return” violations may also be registered as events negatively impacting an overall driver rating (discussed further herein below) of the tardy current borrower of the vehicle.

Moreover, the system actively updates a listing of shared vehicle availability information (locations and time periods) to provide real-time-capable shared vehicle reservation functionality. At any point in time, a potential lender (including a current borrower) can register availability information for shared vehicle. Such information can be provided for some time period that begins in the future. In such case, the location will be identified as “tentative” to indicate the location will be confirmed by “actual” at some time in the future when the current user parks the shared vehicle at the intended pickup location for a borrower. In the case where the current user is a primary borrower, the primary borrow designates availability of the shared vehicle by a secondary borrower within a sub-period of a period to which the shared vehicle is assigned to the primary borrower.

The system also supports, in a case where a current request cannot be met based upon current availability information, a prospective borrower registering a “need” for a vehicle at a specified location at some time in the future. The system advertises the specified need to other users of the system. As new availability information is subsequently received, the system attempts to match the received availability information with previously registered, but not yet fulfilled, needs of perspective borrowers.

The system supports one-way possessions by borrowers of shared vehicles. Thus, two or more consecutive loans of a shared vehicle may be chained together such that the shared vehicle will eventually be returned to a destination specified by an original lender at the end of a loan period for the shared vehicle. Thus, the shared vehicle need not be returned to the original lender by a primary borrower. At each point along the chained loans, the system registers possession transfers, and this information is accessible by the original lender via a tracking functionality of the system.

The system supports original lenders advertising their willingness to subject their shared vehicles to nested vehicle sharing. Such willingness may enhance the desirability of particular shared vehicles since primary borrowers may reduce their cost by allowing a secondary borrower to use the vehicle during a sub-period of a time period within which the vehicle is loaned by an original lender to a primary borrower.

It will be appreciated that while the principles described herein are most widely applicable to telematics units incorporated into over-the-road vehicles, the teachings are also potentially applicable to other shared vehicles such as heavy machinery equipped with telematics units. In heavy machinery, various operational parameter values (e.g., maximum payload weight, duration of operation under high power/torque demand conditions) can be acquired and stored to identify potentially destructive abusive operation of rented heavy machinery by a lessee.

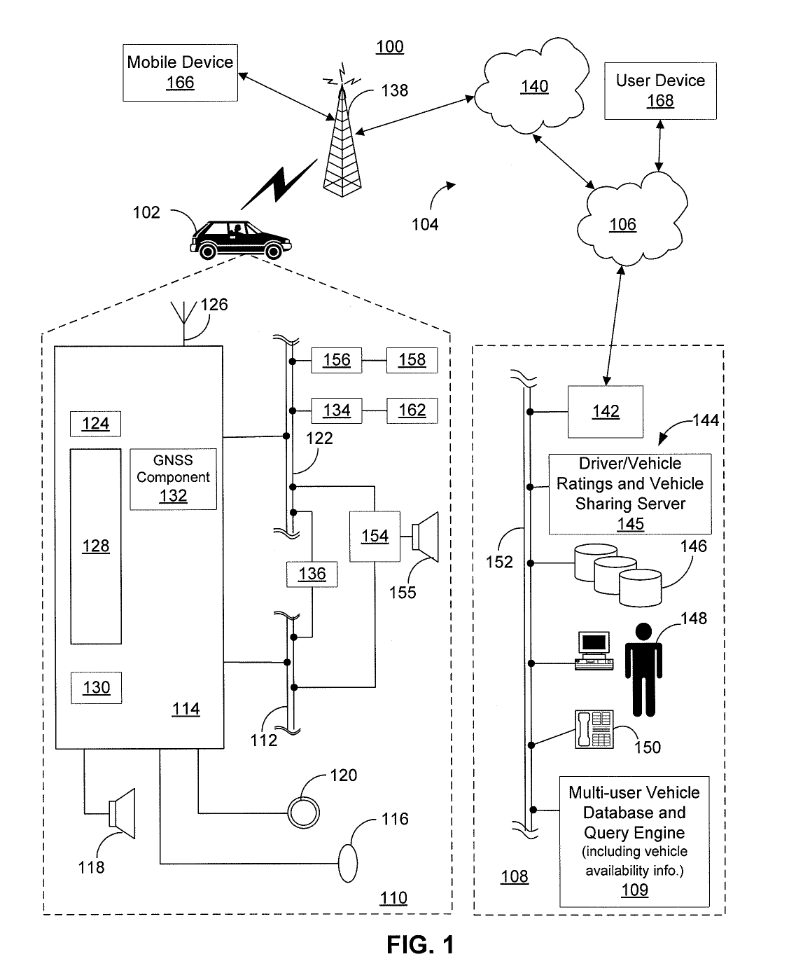

An exemplary computing and network communications environment is described hereinafter. It will be appreciated that the described environment is an illustrative example, and does not imply any limitation regarding the use of other environments to practice the invention. With reference to FIG. 1 there is shown an example of a communication system 100 that may be used with the present method and system to pass vehicle and driver information. The communication system 100 generally includes a vehicle 102, a mobile wireless network system 104, a land network 106 and a communications center 108. It should be appreciated that the overall architecture, setup and operation, as well as the individual components of the communication system 100 is generally known in the art.

In accordance with an illustrative example, the communication center 108 includes a multi-user vehicle database and query engine (database and query engine) 109. The database and query engine 109 is configured to include functional components facilitating updates to vehicle and/or user tables maintained on the database and query engine 109 that contains both vehicle and user information relating to operation of vehicles by drivers. The database and query engine 109 maintains a multitude of both current status information as well as historical information (both driver and vehicle) upon which rating criteria are applied to render vehicle and driver ratings. Such ratings include individual characteristic ratings as well as one or more composite ratings for drivers/vehicles. Composite ratings, based upon fewer than all driver/vehicle characteristics, are combined according to weightings specified in overall rating criteria for drivers and vehicles to render an overall rating for each. As such, a variety of rating criteria are applied to vehicle and user information retrieved from the multi-user vehicle database and query engine 109 to render a variety of individualized ratings for users and vehicles in a multi-user vehicle user environment.

Moreover, in accordance with an implementation of a system supporting nested vehicle sharing, the database and query engine 109 maintains a vehicle availability table including records/entries (see e.g., FIG. 5) specifying vehicle availability information. By way of example, each vehicle availability information record/entry includes: a geographic location and a period of availability. In addition, the vehicle availability information record/entry specifies one or more user rating values that identify thresholds for primary and secondary borrowers of the vehicle associated with the vehicle availability information record/entry. The geographic location within vehicle availability information for a particular vehicle is intended to specify a pickup/drop-off point for the vehicle by a borrower within the specified period. In addition, a current location, updated in real time, is also specified to facilitate specifying a pickup/drop off point differing from a current geographic location of the vehicle that can be consulted by a lender/borrower to ensure availability of a particular vehicle at a designated time. The vehicle availability information further specifies reservations that impact the availability of the identified shared vehicle at some point in the future. The presence of the above-described vehicle availability table within the database and query engine 109, and the inclusion of availability information specifying a sub-period within a primary borrower's loan period, in searches for available vehicles for perspective borrowers, facilitates nested vehicle sharing wherein a secondary borrower uses a shared vehicle within a sub-period of a primary borrower's period of use.

The vehicle 102 is, for example, a motorcycle, a car, a truck, a recreational vehicle (RV), a boat, a plane, etc. The vehicle 102 is equipped with suitable hardware and software that configures/adapts the vehicle 102 to facilitate communications with the communications center 108 via mobile wireless communications. The vehicle 102 includes hardware 110 such as, for example, a telematics unit 114, a microphone 116, a speaker 118 and buttons and/or controls 120 integrated with the telematics unit 114. In an instructional mode of operation of the telematics unit 114, the speaker 118 is used to issue an audible notification to a user when a bad driving event has been sensed that is passed via message within the communication system 100 from the vehicle 102 to the communications center 108.

The telematics unit 114 is communicatively coupled, via a hard wire connection and/or a wireless connection, to a vehicle bus 122 for supporting communications between electronic components within the vehicle 102. Examples of suitable network technologies for implementing the vehicle bus 122 in-vehicle network include a controller area network (CAN), a media oriented system transfer (MOST), a local interconnection network (LIN), an Ethernet, and other appropriate connections such as those that conform with known ISO, SAE, and IEEE standards and specifications.

The telematics unit 114 provides a variety of services through communications with the communications center 108. The telematics unit 114 includes an electronic processor 128, electronic memory 130, a mobile wireless component 124 including a mobile wireless chipset, a dual function antenna 126 (both GNSS and mobile wireless signal), and a GNSS component 132 including a GNSS chipset. In one example, the mobile wireless component 124 comprises an electronic memory storing a computer program and/or set of computer-executable instruction sets/routines that are transferred to, and executed by, the processing device 128. The mobile wireless component 124 constitutes a network access device (NAD) component of the telematics unit 114.

The telematics unit 114 provides, for users, an extensive/extensible set of services. Examples of such services include: GNSS-based mapping/location identification, turn-by-turn directions and other navigation-related services provided in conjunction with the GNSS component 132; and airbag deployment notification and other emergency or roadside assistance-related services provided in connection with various crash and or collision sensor interface modules 156 and crash sensors 158 located throughout the vehicle. The telematics unit 114 also supports receiving and forwarding to a multi-user vehicle database and query engine 109, via the mobile wireless component 124, a variety of sensor readings relating to operation of the vehicle 102.

GNSS navigation services are, for example, implemented based on the geographic position information of the vehicle provided by the GNSS component 132. A user of the telematics unit 114 enters a destination, for example, using inputs associated with the GNSS component 132, and a route to a destination may be calculated based on the destination address and a current position of the vehicle determined at approximately the time of route calculation. Turn-by-turn (TBT) directions may further be provided on a display screen corresponding to the GNSS component and/or through vocal directions provided through a vehicle audio component 154. It will be appreciated that the calculation-related processing may occur at the telematics unit or may occur at a communications center 108.

The telematics unit 114 also supports infotainment-related services whereby music, Web pages, movies, television programs, video games and/or other content is downloaded by an infotainment center 136 operatively connected to the telematics unit 114 via the vehicle bus 122 and an audio bus 112. In one example, downloaded content is stored for current or later playback.

The above-listed services are by no means an exhaustive list of the current and potential capabilities of the telematics unit 114, as should be appreciated by those skilled in the art. The above examples are merely a small subset of the services that the telematics unit 114 is capable of offering to users. Moreover, the telematics unit 114 includes a number of known components in addition to those listed above that have been excluded since they are not necessary to understanding the functionality discussed herein below.

The telematics unit 114 uses radio transmissions to establish communications channels with the mobile wireless network system 104 so that voice and/or data signals, including ones containing data corresponding to one or more events used to calculate a vehicle and/or driver rating, can be sent and received via the communications channels. The mobile wireless component 124 enables both voice and data communications via the mobile wireless network system 104. The mobile wireless component 124 applies encoding and/or modulation functions to convert voice and/or digital data into a signal transmitted via the dual function antenna 126. Any suitable encoding or modulation technique that provides an acceptable data rate and bit error can be used. The dual function antenna 126 handles signals for both the mobile wireless component 124 and the GNSS component 132.

The microphone 116 provides the driver or other vehicle occupant with an interface for inputting verbal or other auditory commands to the telematics unit 114, and can be equipped with an embedded voice processing unit utilizing a human/machine interface (HMI) technology known in the art. The speaker 118 provides verbal output to the vehicle occupants and can be either a stand-alone speaker specifically dedicated for use with the telematics unit 114 or can be part of an audio component 154. In either case, the microphone 116 and the speaker 118 enable the hardware 110 and the communications center 108 to communicate with occupants of the vehicle 102 through audible speech.

The hardware 110 also includes the buttons and/or controls 120 for enabling a vehicle occupant to activate or engage one or more components of the hardware 110 within the vehicle 102. For example, one of the buttons and/or controls 120 can be an electronic push button used to initiate voice communication with the communications center 108 (whether it be live advisors 148 or an automated call response system). In another example, one of the buttons and/or controls 120 initiates/activates emergency services supported/facilitated by the telematics unit 114.

The audio component 154 is operatively connected to the vehicle bus 122 and the audio bus 112. The audio component 154 receives analog information via the audio bus, and renders the received analog information as sound. The audio component 154 receives digital information via the vehicle bus 122. The audio component 154 provides AM and FM radio, CD, DVD, and multimedia functionality independent of the infotainment center 136. The audio component 154 may contain a speaker system 155, or may utilize the speaker 118 via arbitration on the vehicle bus 122 and/or the audio bus 112.

The vehicle crash and/or collision detection sensor interface 156 is operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

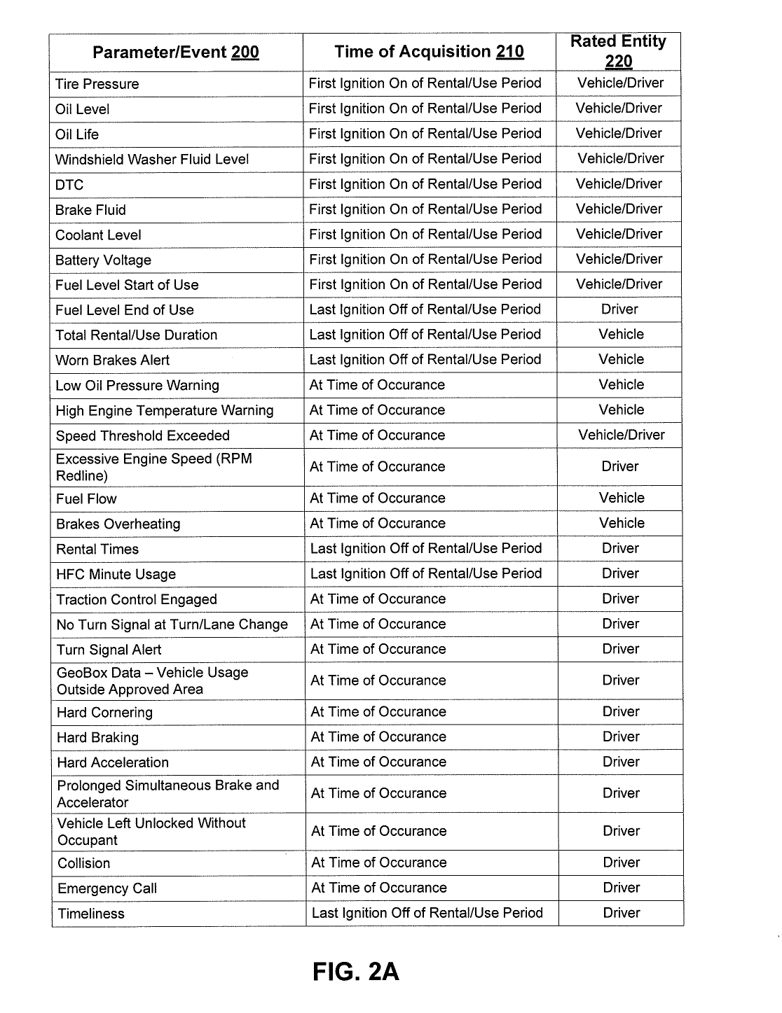

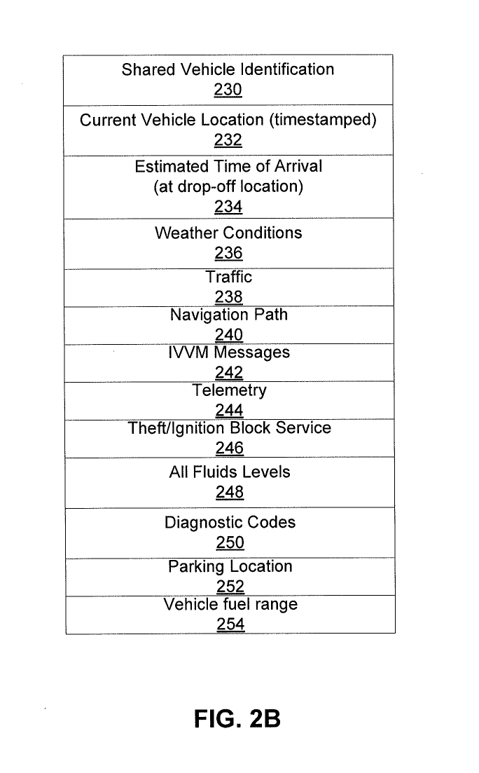

A set of vehicle sensors 162, connected to various ones of a set of sensor interface modules 134 are operatively connected to the vehicle bus 122. Examples of the vehicle sensors 162 include but are not limited to gyroscopes, accelerometers, magnetometers, emission detection and/or control sensors, and the like. Examples of the sensor interface modules 134 include ones for power train control, climate control, and body control. Data from the sensor interface modules 134 is provided to automobile electronic control units, including an engine control unit (ECU), not shown in FIG. 1. Furthermore, in accordance with an illustrative example, the data provided by the sensor interface modules 134 is provided (either directly via the vehicle bus 122 or indirectly via the ECU) to the telematics unit 114. By way of example, the telematics unit 114, selectively processes and forwards signal values acquired via the sensors 162, in accordance with a configured signal data acquisition/filtering scheme. The forwarded signal values are received by, for example, a driver and vehicle ratings and vehicle sharing server (shared vehicle server) 145. The shared vehicle server 145 thereafter submits the received signal values via database request messages to the multi-user vehicle database and query engine 109. Examples of the types of information passed to the multi-user vehicle database and query engine 109 are described herein below with reference to FIG. 2.

The mobile wireless network system 104 is, for example, a cellular telephone network system or any other suitable wireless system that transmits signals between mobile wireless devices, such as the telematics unit 114 of the vehicle 102, and land networks, such as the land network 106. In the illustrative example, the mobile wireless network system 104 includes a set of cell towers 138, as well as base stations and/or mobile switching centers (MSCs) 140, as well as other networking components facilitating/supporting communications between the mobile wireless network system 104 with the land network 106. For example, the MSC 140 includes a remote data server.

As appreciated by those skilled in the art, the mobile wireless network system includes various cell tower/base station/MSC arrangements. For example, a base station and a cell tower could be co-located at the same site or they could be remotely located, and a single base station could be coupled to various cell towers or various base stations could be coupled with a single MSC, to name but a few of the possible arrangements.

Land network 106 can be, for example, a conventional land-based telecommunications network connected to one or more landline end node devices (e.g., telephones) and connects the mobile wireless network system 104 to the communications center 108. For example, land network 106 includes a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

The communications center 108 is configured to provide a variety of back-end services and application functionality to the hardware 110. The communications center 108 includes, by way of example, network switches 142, servers 144 (including the shared vehicle server 145), databases 146, live advisors 148, as well as a variety of other telecommunications equipment 150 (including modems) and computer/communications equipment known to those skilled in the art. These various call center components are, for example, coupled to one another via a network link 152 (e.g., a physical local area network bus and/or a wireless local network, etc.). Switch 142, which can be a private branch exchange (PBX) switch, routes incoming signals so that voice transmissions are, in general, sent to either the live advisors 148 or an automated response system, and data transmissions are passed on to a modem or other component of the telecommunications equipment 150 for processing (e.g., demodulation and further signal processing).

The servers 144, as noted above, include the shared vehicle server 145. By way of example, the shared vehicle server 145 is configured with an Internet interface facilitating providing ratings services to a variety of user/subscribers specifying ratings thresholds for minimally qualified drivers and/or vehicles and retrieving responsive driver and/or vehicle ratings information for drivers and/or vehicles meeting the ratings thresholds. In a typical scenario, vehicle owners specify minimal ratings requirements for potential users of their vehicles. Thereafter, rated users logon to the shared vehicle server 145 and specify minimal ratings requirements for potential vehicles. In response to the shared vehicle server 145 queries the multi-user vehicle database and query engine 109 to determine the intersection of a set of vehicles meeting the rated user-specified minimum vehicle rating AND the set of vehicles for which the rated user meets vehicle owner-specified minimum driver rating. The resulting set of vehicles are returned to the shared vehicle server 145 for presentation to the requesting rated user. Thus, the shared vehicle server 145 simultaneously applied bi-directional exclusion preferences/rules specified by rated users for rated vehicles. The automated nature of the filtering procedure when a rated user specifies minimum vehicle ratings is dependent upon the ability of both users and vehicles to both: (1) be rated and (2) specify a threshold rate for candidate vehicles/users.

To that end, the shared vehicle server 145 is also configured with a database query interface facilitating submitting structured queries to the multi-user vehicle database and query engine 109 and receiving/processing subsequent responsive vehicle/driver data. In general, the shared vehicle server 145 responds to ratings requests from users, acquires relevant data from the tables maintained by the multi-user vehicle database and query engine 109, applies specified ratings criteria to the acquired data, and renders responsive ratings to the requesting users. The functionality of the shared vehicle server 145, including exemplary ratings algorithms, are described, by way of example herein below.

The telecommunications equipment 150 includes, for example, an encoder, and can be communicatively connected to various devices such as the servers 144 and the databases 146. For example, the databases 146 comprise computer hardware and stored programs configured to store subscriber profile records, subscriber behavioral patterns, and other pertinent subscriber information. Although the illustrated example has been described as it would be used in conjunction with a manned version of the communications center 108, it will be appreciated that the communications center 108 can be any of a variety of suitable central or remote facilities, which are manned/unmanned and mobile/fixed facilities, to or from which it is desirable to exchange voice and data.

It will be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism. Thus, for example, the operations performed by the telematics unit may be carried out according to stored instructions or applications installed on the telematics unit, and operations performed at the call center may be carried out according to stored instructions or applications installed at the call center.

FIG. 2A provides an exemplary set of data element types corresponding to measurements acquired, processed and forwarded by the telematics unit 114 (either directly or via the shared vehicle server 145) to the multi-user vehicle database and query engine 109. A column 200 identifies a measurement type. A column 210 identifies a description of when an event is generated to cause the acquisition of a value for the particular measurement type by the telematics unit 114 which thereafter forwards a measured value/event of the identified type for storage in the database and query engine 109. A column 220 identifies an entity type (vehicle, driver, or both) to which the measurement pertains.

As shown in the illustrative example, multi-user vehicle parameter values that are acquired and forwarded by the telematics unit 114 when a user initially turns on the vehicle 102 a first time during a period of use include: tire pressure, oil level, oil life, windshield washer fluid level, diagnostic trouble codes (DTC—a list indicating each trouble code that has been set during the current use of the vehicle), brake fluid, coolant level, battery voltage, and fuel level. Each of these, in some cases critical, readings is pertinent to vehicle operation, safety and maintenance. Moreover, storing a second value from the sensors responsible for providing each of these parameters at the end of a vehicle use facilitates establishing additional driver rating parameter information. In particular, information indicative of the driver's treatment and care for a temporarily used vehicle can be obtained by comparing the stored end of use value to the beginning of use value for each parameter. The comparison values can be used to establish further driver rating data used to render an overall composite driver rating.

In a particular example, a fuel level at the beginning of a use period, by itself, contributes to the vehicle's rating. A fuel level value while the vehicle is awaiting a next use contributes to a particular vehicle's readiness rating. A very low fuel level would result in a lowered rating for the vehicle to reflect the general desirability of a reasonably full tank at the beginning of a use. The fuel level at the end of a use is compared to a fuel level at the beginning of a use to rate a driver's tendency to re-fill prior to the dropping off a vehicle. A driver that tends to leave less gas in the tank at an end of use than at the beginning is generally a less desirable, and thus lower rated, user.

Additional rating parameters, taken at the end of a use period to contribute to an overall vehicle rating include: total duration of use (actual drive time) and worn brakes alert.

During operation, any warning sensor relating to the operational status of the vehicle 102 may be used to render an overall rating for a vehicle with regard to the state of maintenance or as an indication of latent damage that would render a lower vehicle rating. Such sensor readings include: low oil pressure, high engine temperature, fuel flow disruption, overheating brakes, vehicle speed threshold exceeded, engine speed threshold (redline) exceeded, etc.). These warnings are critical and thus are immediately processed and forwarded by the telematics unit 114 to the shared vehicle server 145. When these warnings are registered, a warning message may separately be issued by the shared vehicle server 145 or other service associated with the communications center 108 to minimize damage to the vehicle. Some of the above instantaneous warnings that contribute to vehicle ratings, such as the vehicle/engine speed threshold exceeded warning, may also contribute to driver ratings.

Turning to parameters that may be used to rate a driver/user of a vehicle, a number of parameters are acquired at the end of a user period that contribute to a driver rating. Such parameters include: total time of use period, number of rentals/uses, and hands-free calling minutes used (HFC). Such multi-user vehicle parameter values are acquired and forwarded by the telematics unit 114 when a user turns off the ignition (if at the end of a rental/shared use period) and forwarded to the shared vehicle server 145 for processing and updating a driver's history maintained in the multi-user vehicle database and query engine 109.

With continued reference to FIG. 2A, driver rating related events/measurements that are forwarded by the telematics unit 114 during assignment of the vehicle to a particular driver include the following: vehicle speed threshold exceeded, traction control engaged, no turn signal during turn/lane change, turn signal left on after lane change completed, hard cornering, hard braking, hard acceleration, prolonged simultaneous activation of brake and accelerator, excessive engine speed, vehicle collision, and vehicle left unlocked after driver exits vehicle. Moreover, an emergency call during a use period may be used for rating a driver by covering all instances where emergency service is needed instead of just collisions. Additionally, in cases where use is geographically limited, traveling outside a specified geographic region registers a violation of such use limitation. It is noted that the above identification of potential data acquired and forwarded by the telematics unit 114 to the shared vehicle server 145 for processing and storage in the multi-user vehicle database and query engine 109 is exemplary in nature. The intention is to demonstrate the capability of the telematics unit to acquire a vast variety of information that is potentially used to establish ratings for drivers/users and multi-user vehicles.

Moreover, the illustrative example contemplates providing timeliness information relating to adherence by a borrower of a vehicle to an agreed time for delivering a shared vehicle to an agreed drop-off location at/before an agreed time. The timeliness parameter may be a discrete value (e.g., one of a finite number of grades) or a continuous value. The value may be objectively calculated from a variety of factors (e.g., size of delay, percentage of total time, affecting a subsequent use, etc.) or subjectively assigned values of the lender. The timeliness value assigned to a particular use is combined with timeliness values assigned during other uses by the particular identified driver to render an overall timeliness rating for a user. Individual instances of timeliness ratings used to calculate the overall timeliness rating may be maintained to provide additional information to a perspective lender of a vehicle. Also, a variety of overall timeliness calculation methods are contemplated/supported (e.g., time-based filtering, sample order sequence filtering) allowing perspective lenders to individually specify a filtering/weighting scheme for calculating a driver rating for timeliness. Such filtering/weighting designation flexibility is facilitated by maintaining a set of previously received timeliness ratings from previous borrowing instances by a particular identified driver.

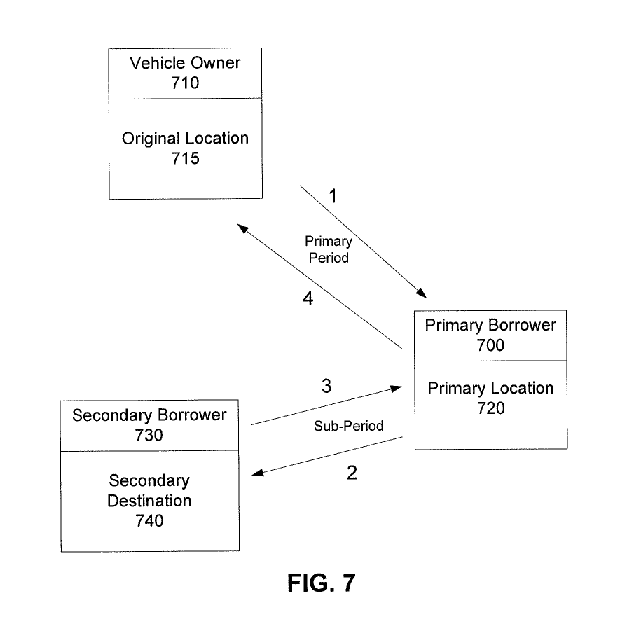

Turning to FIG. 2B, a set of fields are identified corresponding to a set of vehicle status parameters maintained within the multi-user vehicle database and query engine 109, augmenting the driver/vehicle rating-related data elements summarized in FIG. 2A to facilitate real-time management of nested sharing of a vehicle during a period wherein the vehicle is already on loan to a primary borrower. The collection of information set forth in FIG. 2B is intended to summarize a current operational state of a particular vehicle—a form of real-time status tracking/snapshot of a particular shared vehicle—to facilitate real-time management, without need for any human intervention, of potentially nested uses of the shared vehicle. The function and/or purpose of information stored the identified fields indicative of a current vehicle status are further discussed in the context of a nested sharing method described herein below with reference to FIGS. 6 and 7. The exemplary, illustrative, vehicle status parameters enumerated and summarized in FIG. 2B, potentially enhance reliability of the described system where potentially multiple parties rely upon a successful cascade of successful (vehicle return/hand-off) events in order to satisfy each user's expectations regarding the availability of a vehicle subjected to nested sharing.

A shared vehicle identification 230 uniquely identifies the vehicle in the system. Such unique vehicle identification can be taken from any of a variety of sources, including a unique identification assigned to a telematics unit through which the vehicle communicates with the vehicle sharing server 145.

A time stamped current vehicle location 232 and an estimated time of arrival (at the agreed hand-off location) 234, are maintained within the database and query engine 109 to enable the system to notify/inform perspective borrowers of the identified vehicle whether the identified vehicle will be available at particular time and place of interest (e.g., at the designated drop-off point at the end of an agreed upon period of use).

A current weather conditions 236 contains a description/code identifying a current weather state that may impact expected travel time to a destination or agreed upon hand-off point.

A traffic conditions 238 specifies current traffic status along a contemplated navigation path of the shared vehicle. The traffic conditions 238 are potentially applied to the travel plans to provide warnings regarding drop-off deadlines in the event that traffic conditions are likely to increase travel times substantially.

A navigation path 240, calculated based upon the current vehicle location 232 and a specified hand-off destination for the vehicle, is used in conjunction with the traffic conditions 238 and the weather conditions 236 to calculate currently expected time of return for the vehicle at the hand-off location and issue appropriate warnings if a vehicle drop-off deadline is in danger of not being met based upon current traffic and weather conditions on the contemplated navigation path. In an illustrative example, such warnings are queued within and issued from an in-vehicle voice messages (IVVM) field 242.

Additionally, a variety of operating parameters are stored in a telemetry 244 field. The telemetry data includes current velocity (speed and direction), location coordinates, and various vehicle operating state information. Such information is acquired periodically (e.g., every 30 seconds) and sent via the mobile wireless interface of the telematics system 114 every 5 minutes to the shared vehicle server 145 and stored in the multi-user vehicle database and query engine 109.

A theft/ignition block service 246 stores a current alarm status of an activated theft/ignition block service in vehicles supporting such service.

An All Fluid Levels 248 comprises a composite alert element that is raised if any one of several monitored fluids is detected as being low. Examples of monitored fluids include coolant, brake, oil, and wash fluids. If a low fluid level is detected for any one of the fluid types, an alert flag is raised that invokes a set of remedial operations based upon the type of fluid detected as being low.

A Diagnostic Codes 250 is a composite alert that is raised if any one of several monitored diagnostic tests fails. The Diagnostic Codes parameter is set in order to put the owner, current borrower, and any potentially interested borrowers on notice of the possibility that the vehicle may not be available due to a detected malfunctioning vehicle component.

A parking location 252 identifies the exact location (geospatial coordinates) where a vehicle has been parked. This enables a next user to find a vehicle potentially stored in a large parking lot by merely entering exact coordinates. A next user of the vehicle, for example, receives the coordinates via the next user's smart-phone, and the coordinates are applied to a navigation application on the smart-phone to direct the next user to the specific parking location—as opposed to merely providing a general location of the vehicle. Such capability enables users to optionally return a vehicle to a free parking space on a street instead of using a paid parking lot to execute a handover of the vehicle between two users.

A current fuel range 254 provides an estimate of remaining travel distance before the vehicle needs to be re-filled.

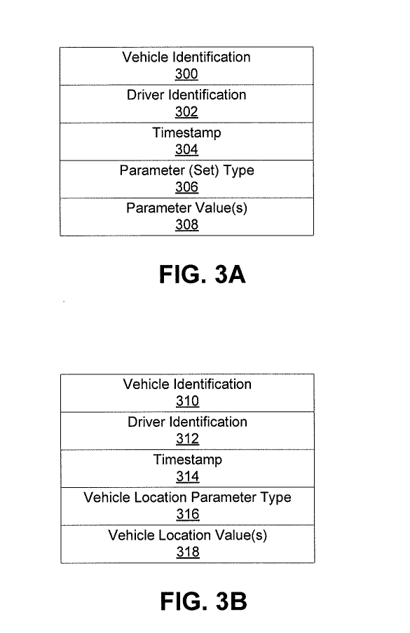

FIG. 3A provides an exemplary message data format for messages passed by the telematics unit 114 to the multi-user vehicle database and query engine 109. By way of example, the exemplary message format includes the following data payload: vehicle ID 300, driver ID 302, time stamp 304, parameter type 306, and parameter value(s) 308. The set of parameters included for a single incident (e.g., a collision instance) can be substantial and include a variety of relevant information including: vehicle speed at time of contact, location of contact on vehicle, braking status, accelerator status, etc. It is noted that such messages can be combined/packed into a single message transmission, from the telematics unit 114 to the shared vehicle server 145 for storage on the multi-user vehicle database and query engine 109, comprising multiple individual messages. The multi-user vehicle database and query engine 109 unpacks and tables the multiple received individual messages within contained within the single message transmission.

FIG. 3B provides an exemplary message data format for real-time vehicle location messages periodically passed by the telematics unit 114 to the shared vehicle server 145 for storage on the multi-user vehicle database and query engine 109. The message format depicted in FIG. 3B is actually a particular example of the generalized message format summarized in FIG. 3A. By way of example, the exemplary message format includes the following data payload: vehicle ID 310, driver ID 312, time stamp 314, vehicle location parameter type 316, and vehicle location value 318. In the case where the vehicle location message is issued by a currently borrowed shared vehicle, the vehicle location parameter value and vehicle/driver identifications are used to identify a drop off location for the shared vehicle. The shared vehicle server 145 uses the current location and identified drop off location to generate an estimated time of arrival for the identified vehicle at the drop off location. The estimated time of arrival is thereafter used to provide appropriate notifications (alerts, warnings, etc.) to one or more interested parties, including an owner, a current lender, a current borrower, a future borrower (based on a reservation). The location information contained in the message structure depicted in FIG. 3B is digested to render the location-reliant data fields of the vehicle status depicted in FIG. 2B.

The shared vehicle server 145, by way of example, processes the raw data provided by telematics units, such as the telematics unit 114, relating to both drivers/users and multi-user vehicles registered in the system. A vast variety of criteria are potentially applied to render both specific ratings for a category (e.g., maintenance, hard driving, timeliness etc.) as well as an overall rating. By supporting categories for ratings, potentially complex rating requests are supported wherein multiple ratings are specified (by either vehicle owners or driver/users) for particular categories to reflect importance of preferences of individual participants in the system. For example, a car owner may not be as concerned whether a particular person always re-fills the tank as long as the driver is considered a gentle driver and returns the vehicle in a timely manner at/before the end of an agreed period of use. The various levels for rating components are established according to standards/ratings rules. In some cases, a rating begins at a highest level initially and is lowered in response to negative events (e.g., a driver exceeds the speed threshold set for a vehicle). Moreover, a time-weighted aspect to ratings may also be used to reduce the relevance of events (both good and bad) that may have previously carried a heavy weighting at the time of occurrence. Thus, good as well as bad events become less important to a current rating of a vehicle or driver/user over time (or multiple subsequent uses). As can be seen from the above discussion, there are many potential ways to assign a rating (or multiple category-based rating) to vehicles and user/drivers.

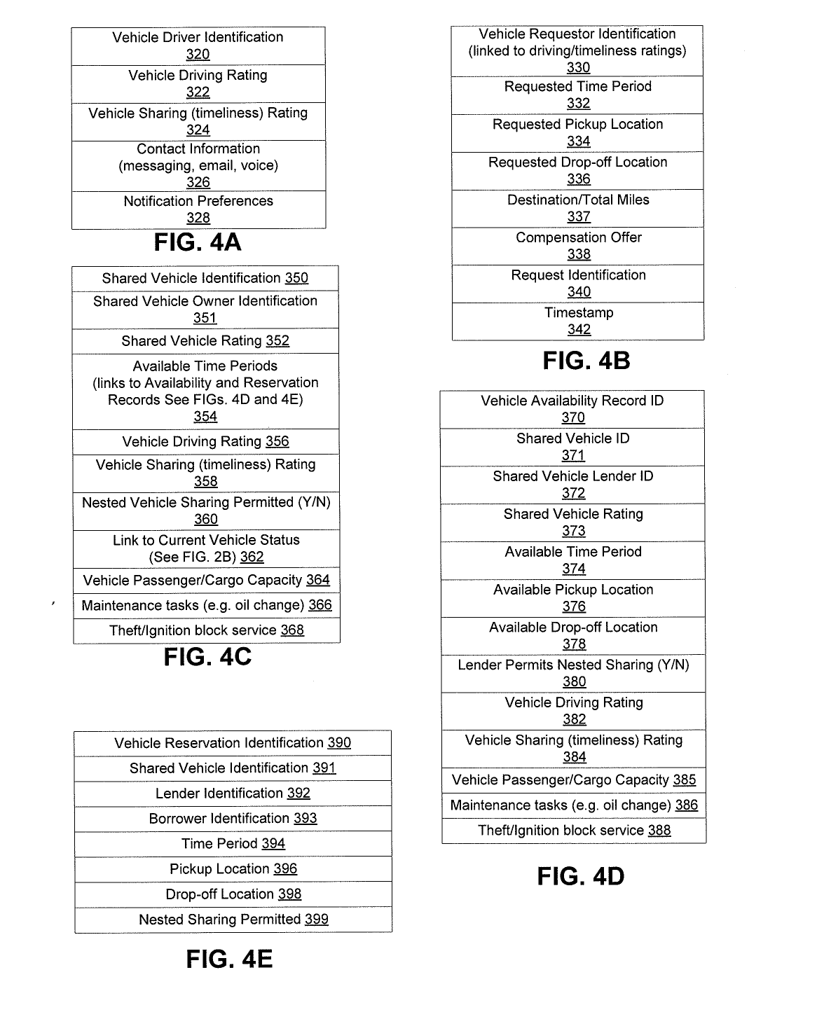

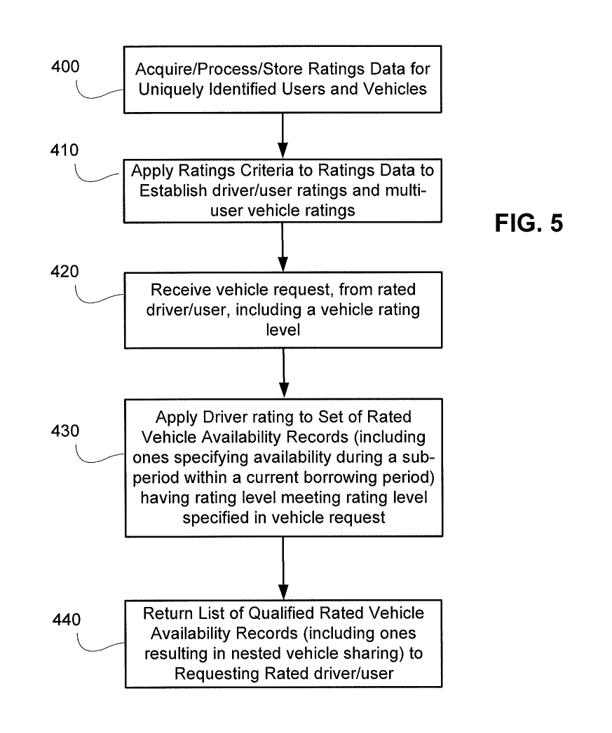

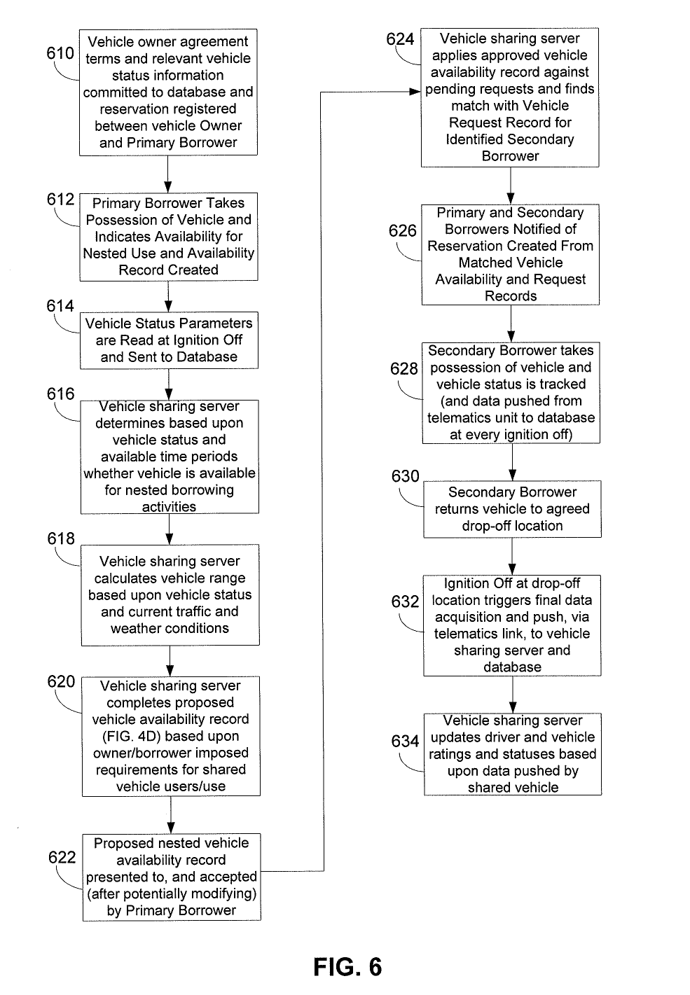

Turning to FIGS. 4A, 4B, 4C, 4D and 4E a set of exemplary information fields are summarized relating to identified vehicle drivers and shared vehicles. Such information, maintained within the multi-user vehicle database and query engine 109, facilitates a vehicle sharing negotiation and tracking system that supports nested vehicle sharing. FIG. 4A provides an exemplary combination of information fields summarizing an identified driver for purposes of matching available shared vehicles with drivers seeking to use shared vehicles. A driver identification 320 uniquely identifies a driver throughout the system. A vehicle driving rating 322 is a composite value rendered from a combination of data points arising from previous uses of shared vehicles by the vehicle driver. A vehicle sharing timeliness rating 324 is a composite value rendered from individual timeliness grades/ratings assigned to previous uses of shared vehicles by the identified vehicle driver. Returning a vehicle later than an agreed time will result in a lower grade for timeliness in the particular instance of use, and the lower grade will be factored into the overall vehicle sharing timeliness rating assigned to the identified driver. The value assigned to the vehicle sharing timeliness rating 324 for an identified driver is particularly important in the context of nested vehicle sharing since returning a vehicle later than agreed can have a domino effect on the timeliness of subsequent “returns” as a series of previously created nested uses is reversed by a series of returns.

The driver information identified in FIG. 4A also includes a contact information 326 providing various addresses and phone numbers relating to a variety of methods for reaching the driver (e.g. instant messaging, email, voice call). The driver information also specifies a notification preference 328 identifying preferences for receiving notifications. The notification preference 328, by way of example, includes multiple entries, wherein each entry specifies a type of notification information and a corresponding preferred notification channel for receiving the particular type of notification information.

FIG. 4B provides an exemplary combination of information fields summarizing a shared vehicle request for purposes of matching available shared vehicles with drivers seeking to use shared vehicles. A shared vehicle requestor (driver) identification 330 specifies the unique driver identification (see FIG. 4A, vehicle driver identification 320) that submitted a shared vehicle request. A requested time period 332 specifies the start and end time of a period within which a shared vehicle use is requested. In addition, a vehicle request specifies a requested pickup location 334 and a requested drop off location 336 for the shared vehicle. Furthermore, a destination/total miles 337 provides a way for the requestor to indicate a point of destination (assuming a round trip) or a total number of miles. The contents of the destination/total miles 337 may be analyzed by the system during evaluation of valid requests (in view of the stated pick up and drop off times) and notify either the requestor or potential vehicle lenders that it is unlikely, given the intended destination or total miles driven, the vehicle can be returned within the stated time period. Thus, a navigation processor can apply the specified start, destination, and end points to a navigation database (potentially using real-time traffic and weather data) and issue a warning to the requestor that the period specified in the requested time period 332 is not sufficient to complete the identified travel plan and identify a time period that would potentially meet the needs of the requestor.

An illustrative example also supports a requestor-supplied offer for compensation specified in a compensation offer 338 portion of the vehicle request data structure depicted in FIG. 4B. In an illustrative example, a shared vehicle request record instance containing the above-described information fields is created within the multi-user vehicle database and query engine 109 and assigned a unique vehicle request record identifier 340. A timestamp 342 contains a time of submission of the request to facilitate equitably fulfilling vehicle requests that are placed in a “standby” state because they cannot be matched immediately with a shared vehicle availability record instance (see FIG. 4B).

FIG. 4C provides an exemplary set of fields associated with a vehicle that is available for sharing within the context of the system described herein including the vehicle sharing server 145 and the multi-user vehicle database and query engine 109. A shared vehicle identification 350 comprises a unique identifier assigned to a particular vehicle in the system. The assigned vehicle identification link the vehicle to a variety of information maintained by the system. A shared vehicle owner identification 351 provides a unique identifier assigned to an owner of the vehicle.

A shared vehicle rating 352 is a composite value generated by the system applying a rating formula to previously acquired vehicle rating information (see FIGS. 2A and 2B) stored in the multi-user vehicle database and query engine 109.

An available time periods 354 is a multi-function structure storing an overall schedule indicating when the identified vehicle is available for borrowing. Additionally, the available time periods 354 stores references to structures describing parameters associated with each availability period (see FIG. 4D) and reservation (see FIG. 4E). Thus, a particular vehicle owner, via the available time periods 354 structure, can review reservations as well as periods where the vehicle is available for borrowing.

The owner, via a vehicle driving rating 356 field, specifies a minimum rating threshold for any perspective borrower of the vehicle (including a nested secondary borrower from a primary borrower). Similarly, the owner specifies a sharing rating threshold value in a vehicle sharing timeliness rating 358.

The owner, via a nested vehicle sharing permitted 360 field, has absolute authority over designating whether the identified vehicle can be the subject of further nested uses while the identified vehicle is in possession of a borrower. A borrower is not required to make a borrowed vehicle available for nested use. However, if the owner specifies that no nested uses are permitted, then the borrower cannot loan the vehicle out to others during the borrower's period of use of the vehicle.

The shared vehicle descriptor structure depicted in FIG. 4C further comprises a reference 362 field (e.g., identifier, link, pointer, etc.) to a collection of information (see FIG. 2B) describing a current status of the identified vehicle.

A passenger and storage capacity 364 provides a description enabling application of additional filters based upon particular passenger/cargo space needs of a borrower.

A maintenance service field 366 specifies a list of maintenance tasks, such as oil change, that are currently needed for the identified vehicle and associated compensation offers by the vehicle owner for each listed task.

A theft/ignition block security service 368 indicates whether the vehicle is equipped with activatable anti-theft equipment/services and associated costs.

FIG. 4D provides an exemplary combination of information fields summarizing an identified shared vehicle availability record for purposes of matching available shared vehicles with drivers seeking to use shared vehicles. A shared vehicle availability record identification 370 uniquely identifies a particular instance of an offer to loan out use of a vehicle that is identified uniquely in a shared vehicle identification 371 (corresponding to the value in shared vehicle identification 350).

The structure identifying an available time frame for using a vehicle also includes a shared vehicle lender ID 372. The shared vehicle lender ID 372 differs in function from the shared vehicle owner identification 351. The entity identified in lender ID 372 is potentially a borrower that has been given permission (based on field 360) to engage in nested sharing relationships with other potential users of the borrowed vehicle. The

[symbol]

A shared vehicle rating 373 is the composite value generated by the system applying a rating formula to previously acquired vehicle rating information (see FIGS. 2A and 2B) stored in the multi-user vehicle database and query engine 109 and also found in the shared vehicle rating field 352 of the primary vehicle descriptor structure depicted in FIG. 4C. An available time period 374 specifies a period within which the identified shared vehicle is available for use by a borrower. If a particular vehicle is available for multiple time periods, a separate record (including the fields depicted in FIG. 4D) is created for each one of the multiple availability periods (including ones nested within other shared vehicle periods). An available pickup location 376 and an available drop-off location 378 specify where the vehicle, identified in the shared vehicle identification 371, is available to be picked up at the beginning of a period of use and dropped off at the end of the period of use.

A lender permits nested sharing 380 specifies whether the offering lender of the vehicle will permit the borrower, in turn, to make the vehicle available for further nested borrowing within the period of use specified in the available time period 374. Designating “no nested sharing” prevents the borrower from, in turn, seeking to loan out the borrowed vehicle.

Moreover, a vehicle driving rating 382 and a vehicle sharing (timeliness) rating 384 facilitate owners/lenders specifying a minimum/threshold value that is desired (but not necessarily required) for any borrower of the vehicle. In an illustrative example, a shared vehicle availability record instance containing the above-described information fields is created within the multi-user vehicle database and query engine 109 and assigned a unique vehicle availability record identifier.

Importantly, with continued reference to FIG. 4D, a new shared vehicle availability record instance (for a secondary borrower) can be created based upon an intermediate location where the shared vehicle is/will be parked by a primary borrower (see e.g., FIGS. 6 and 7 described herein below). In such case, the new shared vehicle availability record instance specifies a sub-period of use within a period wherein the shared vehicle is assigned to the primary borrower. The new shared vehicle availability record instance specifies a pickup location corresponding to the intermediate (parking) location. To ensure that an owner's original intentions are carried out with regard to acceptable drivers, a “child” shared vehicle availability record instance for nested vehicle sharing must specify driving and timeliness ratings (in fields 382 and 384 of a vehicle availability record) that meet or exceed the ratings specified in a “parent” availability record for the shared vehicle. Such further creation of child shared vehicle availability record instances, specifying a sub-period within a primary borrowing period, facilitates brokering, reserving, and tracking—without any manual assistance or intervention—instances of nested vehicle sharing within a loan period for a primary vehicle borrower, by a secondary vehicle borrower. Certain fields of the shared vehicle descriptor structure depicted in FIG. 4C are copied into the shared vehicle availability record 4D to provide convenient access to relevant vehicle usage features and limitations without having to query to the database 109 (using the shared vehicle ID 371 as a search key). In the illustrative embodiment, a vehicle passenger/cargo capacity 385, a maintenance tasks 386 and a theft/ignition block service 388 correspond to the previously described vehicle passenger/cargo capacity 264, maintenance tasks 366 and theft/ignition block service 368 record fields depicted in FIG. 4C.

Turning to FIG. 4E, a set of fields are identified for an exemplary shared vehicle reservation structure maintained by the database and query engine 109. A vehicle reservation identification 390 provides a unique reference number for each entered reservation. A shared vehicle identification 391 contains the unique identification value for the reserved vehicle that is copied from field 371 of the vehicle availability record instance—now removed from in view of the reservation. The reservation record includes a lender identification 392 value that is copied from the shared lender ID 372 of the vehicle availability record instance. A borrower identification 393 contains the unique requestor identification copied from the vehicle requestor identification 330 of the vehicle request instance upon which the reservation is based. A time period 394 specifies a start and end time for the reservation. A pickup location 396 and a drop-off location 398 correspond to the locations negotiated by the parties to the reservation, unless the requested pickup and drop-off locations specified in the vehicle request (see FIG. 4B, fields 334 and 336) and the vehicle availability (see FIG. 4D, fields 376 and 378).

A nested sharing permitted 399 specifies whether the vehicle identified in the vehicle reservation structure is available for nested sharing while in the possession of the borrower during the specified time period. The nested sharing permitted 399 differs from the nested sharing permitted 360 which is specified by the vehicle owner. The nested sharing permitted 399 allows any borrower, who subsequently becomes a lender, of a vehicle to prevent further nesting of vehicle sharing by a nested borrower of the vehicle. A current borrower can be prevented from offering to lend a vehicle for further nesting during the period specified in the time period 394 by designating “no nesting” in the nested sharing permitted 399 field. Other potential fields (not shown) include ones specifying maintenance tasks (see maintenance tasks 386 described above) agreed to be performed by the borrower during the period of possessing the vehicle.

Turning to FIG. 5, a flowchart summarizes a set of operations performed, in potentially any order and multiple times, by the shared vehicle server 145 to maintain the multi-user vehicle database and query engine 109 and respond to user requests for ratings relating to specified entities, such as an identified driver or vehicle. Such requests are received, for example, by the shared vehicle server 145 via an Internet page accessed by drivers/users through browser applications running on computing devices such as the mobile devices 166 and user device 168. During step 400 vehicle and user data of the types enumerated in FIG. 2 is acquired by telematics units, such as the telematics unit 114, incorporated into vehicles. Such vehicle and user information is transferred from vehicles, via the telematics units and the shared vehicle server 145, to the multi-user vehicle database and query engine 109. In an exemplary embodiment, the shared vehicle server 145 receives messages from the vehicle telematics units containing the data formatted, by way of example, in the manner depicted in FIG. 3. The shared vehicle server 145 extracts the relevant vehicle and user information from the received messages and submits the extracted information to the multi-user vehicle database and query engine 109. The extracted information is thus stored in the multi-user vehicle database and query engine 109. The resulting sets of stored vehicle and user data are associated with particular vehicles and users identified by a system-wide unique identifier. In the case of a vehicle, a vehicle identification number (VIN) provides a unique identification for associating vehicle related information for purposes of rating the vehicle. In the case of a user, a social security number or driver's license number uniquely identifies driver related information for purposes of rating the driver.

During step 410, the shared vehicle server 145 applies any of a multitude of configured ratings criteria specified for vehicles and users, to the stored information for vehicles and users stored in the multi-user vehicle database and query engine 109, to render ratings for a particular vehicle or user. Such ratings can result from any of a wide variety of rating criteria supported by the shared vehicle server 145. Relatively static, pre-configured, ratings criteria are supported by the shared vehicle server 145. On the other hand, the shared vehicle server 145 supports a virtually limitless number of customized criteria. The customized criteria potentially specify particular subsets of the full set of vehicle and driver information types. The customized criteria also potentially specify for particular vehicle and user information types: weights applied to particular types of vehicle and user information, time windows, most recent instances (e.g., last 10 uses), age-based weight given to instances of a designated type (emphasize recent data over older data). Moreover, the shared vehicle server 145 supports a variety of normalized ratings output ranges and types such as: stars, letter grading, numerical (e.g., 0-10), etc. Such ratings can be distinguished based upon whether the rated entity is a user (e.g., a letter grade) and a vehicle (e.g. a star rating). Thus, a very diverse range of both static and highly customized ratings criteria, and a flexible interface for specifying customized ratings, are contemplated in accordance with the present disclosure.

During step 420, the shared vehicle server 145 receives a vehicle request from a rated user via, for example, the mobile device 166 or the user device 168. The vehicle request specifies a vehicle rating level used by the rating server 145 to filter the set of potentially available vehicles for the rated user. Additionally, the request includes the set of information summarized in FIG. 4C. The user is uniquely identified in the system for purposes of retrieving user rating information for purposes of assigning a rating to the requesting user. Thus two applicable ratings-based filters arise from each vehicle request from a rated user: (1) a vehicle filter that renders a list of potentially responsive vehicles; and (2) a user filter that disqualifies potentially responsive vehicles based upon user rating-based limitations specified for individual ones of the responsive vehicles. Further filtering of potentially responsive shared vehicles arises from availability of the shared vehicles (see FIG. 4B, time period and pickup/drop-off locations) during the time period and pickup/drop-off locations specified in shared vehicle requests (see FIG. 4C). Moreover, yet additional filtering may be imposed based upon a timeliness rating (imposed by a vehicle lender) of the requestor and/or a timeliness rating (imposed by a vehicle requestor) of a current driver of a potentially responsive vehicle. The timeliness rating of identified drivers takes on additional importance in the context of nested vehicle sharing support since delayed vehicle return instances can have a domino effect upon subsequent deliveries of the shared vehicle to lenders/borrowers awaiting return of the shared vehicle by nested borrowers.

During step 430, the shared vehicle server 145 applies the above-identified filters associated with the shared vehicle request to retrieved vehicle availability and user information retrieved from the multi-user vehicle database and query engine 109 to render a resulting set of vehicle availability records for potential consideration by the requesting user. Thus, the described system facilitates placing a barrier between available vehicles and user requests that are deemed unsuitable for otherwise available vehicles. The filters specified in the vehicle request (see FIG. 4C) are applied to a set of pending, but not yet fulfilled, vehicle availability record (see FIG. 4B) instances, and the shared vehicle server 145 generates a list of qualified rated vehicle availability record instances.

After generating the list of responsive vehicle availability records, in an illustrative example, during step 440 the server 145 submits, to the requesting rated user, the listing of vehicle availability records meeting the bi-lateral mutual filters specified by the rated user and individual ones of a set of responsive rated vehicle availability records. Thereafter, an interactive negotiation commences between: (1) the perspective borrower (requesting rated user), and (2) the owner and/or lender of the vehicle corresponding to a selected one of the set of responsive rated vehicle availability records. By way of example, the server 145 applies a prioritization/selection criterion to the qualified vehicle requests to automatically generate a ranked set of matches between ones of the responsive vehicle availability records, which is then submitted to the requesting rated user. The user thereafter selects a first one from the ranked listing to commence a negotiation. In yet other illustrative examples, other methods of presenting the responsive availability records are implemented.

The set of operations described herein above with reference to FIG. 5, in particular steps 420, 430 and 440, are performed with regard to a particular vehicle request (see FIG. 4B) instance. However, the server 145 is also configured with appropriate executable instructions and shared vehicle information acquisition interfaces to perform an analogous set of operations to identify a set of pending (unfulfilled) vehicle use request (see FIG. 4B) records responsive to a particular vehicle availability record (see FIG. 4D) instance. In such case, filters specified in the vehicle availability record are applied to a set of pending, but not yet fulfilled, vehicle request records, and the shared vehicle server 145 generates a list of qualified rated driver vehicle request record instances. After generating the list of responsive qualified vehicle request records, in an illustrative example, the server 145 submits the list to the owner and/or current borrower of the shared vehicle. Thereafter, an interactive negotiation commences, for a selected one of the responsive vehicle request records, between: (1) the perspective borrower (requesting rated user), and (2) the owner and/or lender of the vehicle corresponding to a selected one of the set of responsive rated vehicle availability records. The server 145 applies a prioritization/selection criterion to the qualified vehicle request records to render a ranking of responsive shared vehicle requests. It is up to the owner and/or lender to decide which one of the responsive shared vehicle requests that will be the basis for a next negotiated shared use.

Turning to FIG. 6, a flowchart summarizes negotiation of a nested vehicle sharing within a primary period and related actions relating to the nested vehicle sharing. The sequence of stages are intended to be exemplary and focus upon the “nested vehicle sharing” aspect of the system described herein, and in particular to describe enhanced tracking features for ensuring timely hand-off of vehicles between current and next users. During stage 610 an agreement is entered between a vehicle owner and a primary borrower setting terms for the primary borrower to take possession of the vehicle for a period of time. Terms of use for such agreement may be stored in the form of an agreement record having data fields containing a variety of information such as the data depicted in FIG. 4E. The shared vehicle server 145 stores the vehicle sharing agreement to a uniquely identified vehicle reservation record stored on the multi-user vehicle database and query engine 109.

During stage 612 the primary borrower takes physical possession of the vehicle, and the primary borrower indicates availability of the vehicle during a portion of the time the vehicle is on loan to the primary borrower, by creating a vehicle availability record (see FIG. 4D) advertising terms of use for potential borrowers. The system's creating and storing of the vehicle availability record is conditioned/dependent upon the owner (and if previously nested—the lender) specifying that nested sharing is permitted. Such indication of permitted nested sharing is indicated via the nested sharing permitted 399 field in the original reservation/agreement entered during stage 610. Thus, during stage 612 a vehicle availability record instance is created for the currently on-loan vehicle. Such record is accessible, along with other available vehicles, via the shared vehicle server 145 accessing the multi-user vehicle database and query engine 109.

During stage 614 the primary borrower parks the borrowed vehicle at a potential hand-off location for a next borrower of the shared vehicle. When the driver of the vehicle shuts of the engine of the shared vehicle, a variety of vehicle status parameters (see FIG. 2B) are passed via the telematics unit 114 to the shared vehicle server 145, and the server 145 uses the updated information to update status parameters associated with the shared vehicle on the multi-user vehicle database and query engine 109.

During stage 616, the shared vehicle server 145 reads the fields of the previously stored shared vehicle reservation record instance (see FIG. 4E) and corresponding status record of the vehicle identified in the vehicle reservation record to determine whether the corresponding vehicle is available for nested borrowing. When making such determination, the server 145 initially consults the nested sharing permitted 399 field since a “no” value precludes lending the borrowed vehicle during the time of possession. Other fields potentially consulted include the time period 394 (for the current lending period) since a minimum time period for a nesting may be imposed to ensure a sufficient buffer on either end of a nested use (during vehicle hand-off).

In the illustrative embodiment, the server 145 does not determine availability for nesting until the current user has parked the vehicle. This takes uncertainty out of the hand-off time of a vehicle from a lender to a borrower. However, the system may also be configured to permit nested offers even before a current borrower has parked the vehicle at a hand-off location. In yet other embodiments, an availability period in a offer may be conservatively specified while the vehicle is en-route to a lender's parking possession. However, after the vehicle is parked, the availability period specified in field 374 of an availability record is updated with an actual available period beginning time.

During stage 618 the shared vehicle server 145 calculates a vehicle range based upon the vehicle status (e.g., parked location, current weather conditions, current traffic conditions, etc.). The available period of nested use might even be restricted based upon an estimated time that will be needed to return the borrowed vehicle to the original lender once the nested sharing period ends. Based upon all considered factors and limitations, a range for considering potential users of the vehicle is calculated.

During stage 620 the shared vehicle server 145 generates a proposed vehicle availability record including filled-in values for the fields summarized in FIG. 4D. The contents of the fields are based upon a combination of requirements, including requirements mandated by the vehicle owner and a borrower/lender of the vehicle seeking a nested user. Such requirements include a minimum driver rating (driving and sharing—see driving rating 356 and sharing rating 358) to ensure a degree of confidence that a subsequent nested borrower of a vehicle will not damage or abuse the vehicle, or return the vehicle late, during a nested use.

During stage 622 the shared vehicle server 145 presents the proposed shared vehicle availability record to the current possessor (i.e., the primary borrower) of the vehicle. The current possessor accepts (after possibly editing) the shared vehicle availability record.

During stage 624 the shared vehicle server 145 applies the approved vehicle availability record again pending shared vehicle requests (perspective borrowers of the shared vehicle) and subsequently identifies a suitable match between the approved vehicle availability record and a currently pending shared vehicle request. An initial comparison to pending borrower requests may not result in a match. In such case the pending vehicle availability record/offer is checked in response to a subsequent triggering event (e.g. a new borrower request description is received by the shared vehicle server 145).

During stage 626 the shared vehicle server 145 creates a shared vehicle reservation record instance (see FIG. 4E) and issues a notification to both the primary borrower (perspective lender) and a secondary borrower corresponding to the borrower request matched during stage 624. Any of a variety of messaging modes can be used including email, text-to-voice messaging, test message, instant messaging, etc. Also, sufficient information is provided to both the primary borrower (lender) and secondary borrower to access and display the contents of the reservation record instance and related information maintained within the database and query engine 109.

During stage 628 the secondary borrower takes possession of the vehicle at a time and location specified by the time period 394 and the pickup location 396. Importantly, during the period while the second borrower is in possession of the shared vehicle, a variety of status information is provided in response to triggering events. The shared vehicle server 145 receives and stores the information in an instance of vehicle status record of the type depicted in FIG. 2B. For example, telemetry data is acquired every 30 seconds and passed from the vehicle via the telematics unit 114 and stored in the telemetry 244 every 5 minutes. The telemetry data, perhaps more than any other piece of vehicle status, provides a level of confidence/assurance in vehicle lenders that the borrower of a vehicle will operate the vehicle with care and return the vehicle to the agreed drop-off location at/before the agreed time period. During operation, the vehicle sharing server 145 monitors the status of the vehicle and continuously determines an expected time of arrival of the vehicle at the specified drop-off location (field 398) based upon the current location, a calculated navigation path from the current location to the drop-off location, current traffic conditions along the navigation path, and current weather conditions in the area of interest.

The system contemplates applying a variety of global and custom limitations to the telemetry information and other status information (e.g. weather and traffic conditions), and issuing appropriate warnings to relevant parties. For example, based upon the vehicle's current location, drop-off point, navigation path, vehicle telemetry (bearing and speed), weather conditions, and traffic conditions, an alert may issue to the current vehicle borrower to commence returning the vehicle to the drop-off point. Moreover, if the vehicle cannot be returned in time (based upon the above calculations and vehicle status), an alert is issued to at least the current lender and possibly any other “down stream” lender that may be impacted by the late return of the vehicle to the current lender. In the case where the vehicle return is not possible (e.g. a break-down or collision), the vehicle sharing server 145 consults the database and query engine 109 to present alternative vehicles or transportation alternatives for affected users.

The use of vehicle status information (e.g. telemetry) ensures proper use and timely return of a vehicle. If a nested user agrees to use the vehicle to go on a specified trip, the telemetry data will ensure that the vehicle was indeed used for that purpose. Such confirmation by telemetry data ensures that the secondary borrower does not state the use is for a cross-state excursion consisting of primarily interstate highway travel while in-fact the driver uses the vehicle to carry out several local deliveries that subject the vehicle to substantially greater wear and tear. Moreover, the availability of theft/ignition block service provides a degree of assurance that the secondary borrower will take off with the vehicle (i.e. joy ride).

The status information can also be used to ensure compliance with any agreement to perform maintenance tasks. For example, the telemetry data can be used to confirm that the vehicle was at least parked at an oil change service for a selected period of time (if the borrower had agreed to perform such a task. Generally, the updating of the vehicle status record during the course of a nested vehicle sharing period offers a higher degree of assurance and additional compensation opportunities/modes that substantially enhances desirability of permitting nested vehicle sharing to occur on a widespread basis between otherwise unfamiliar lenders/borrowers. Without the added assurances, and objective information to identify responsible parties for any failure to meet a vehicle sharing agreement's terms, the nested vehicle sharing arrangement would be a hard service to sell to vehicle owners and borrower/lenders.

During stage 630 the secondary borrower returns the vehicle to a location specified in the drop-off location 398 of the agreement with the primary borrower/lender. During stage 632 at ignition off, the telematics unit 114 of the shared vehicle acquires and forwards a final set of status data (including telemetry and final parking location coordinates) to the vehicle sharing server 145 for storing on the database and query engine 109. Importantly, the telematics unit 114 provides the geospatial coordinates of the parking location to the vehicle sharing server 145 for presentation to a computer application running on a computing device (preferably portable) available to the primary borrower (e.g. a navigation application/applet running on a smartphone, tablet, notebook computer, desktop computer, etc.). The computer application uses the geospatial coordinates to provide directions leading the user to within a few feet of the parked vehicle.

During stage 634 the vehicle sharing engine 145 uses the information acquired during the course of the vehicle use by the secondary borrower to update driver (sharing and driving) and vehicle ratings. These updated driver and vehicle ratings are thereafter used during subsequent pairing operations of perspective lenders and borrowers of shared vehicles—including enforcing restriction of nested vehicle sharing with drivers meeting a specified minimum rating level for one or both of driving rating and vehicle sharing rating.

Having described examples of systems and processes for implementing aspects of “nested vehicle sharing,” attention is directed to FIG. 7 that depicts an exemplary nested vehicle sharing sequence, including real-time status updates (and related notifications to interested parties). In particular, a primary borrower 700 picks up a shared vehicle, offered by an owner 710, at pickup location 715 (also the drop-off location in this particular example). The owner 710 has agreed to permit the primary borrower 700 to take possession of the shared vehicle for a period of time (e.g., from 8 am to 6 pm during the current day).

After taking possession of the shared vehicle at pickup location 715, the primary borrower 700 drives the shared vehicle to an primary location 720 (e.g., a parking lot at a workplace of the primary borrower 700). During the period of time the shared vehicle is entrusted to the primary borrower 700, the vehicle sharing server 145 (or any other suitably configured programmed server machine) generates/acquires real-time availability information for the shared vehicle including: current shared vehicle location, status (i.e., parked, traveling, etc.) and estimated time of arrival (e.g., at the designated point of return based upon the current shared vehicle location).

During a sub-period (e.g., 9 am to 5 pm) of the period of time, the primary borrower 700 does not need to use the shared vehicle. Therefore, the primary borrower 700, through the telematics unit 114, transmits user-designated vehicle availability information (e.g., time period and pickup/drop-off location(s)) to the vehicle sharing server 145 for submission/tabling on the database and query engine 109.

As noted previously herein, the availability information maintained on the database and query engine 109 is accessed and provided to the vehicle sharing server 145 in response to queries submitted by the server 145 on behalf of perspective vehicle borrowers. The stored vehicle availability information relating to the sub-period (of the period of time to which the primary borrower 700 has taken possession of the shared vehicle) can be pre-stored in the vehicle sharing server 145 (i.e., advertise future availability) before the primary borrower 700 parks the shared vehicle at the primary location 720. In that case, the availability is identified as “tentative” by the vehicle sharing server 145. In cases where the vehicle availability is identified as “tentative,” the server 145 also provides a current location (a general location) as well as an estimate of when the vehicle will arrive at the primary location 720 identified in the vehicle availability entry for the shared vehicle in the database and query engine 109. The “tentative” status is removed when the primary borrower 700 arrives at the primary location 720.

Continuing with the example provided in FIG. 7, a secondary borrower 730 submits a request for a vehicle available in a geographic area during a specified period (e.g., from 11 am until 1 pm). The request may include any number of additional filtering characteristics of a desired car (e.g., size, rental cost, threshold overall car rating, any subfields used to calculate the overall car rating, etc.). The request may further include any number of additional filtering characteristics for a desired driver. The vehicle sharing server 145 submits a query, corresponding to the request from the secondary borrower 730, to the database and query engine 109.

In the illustrative example, the database and query engine 109 returns a list of vehicles meeting the request from the secondary borrower 730. This list includes the vehicle currently on loan to the primary borrower 700. It is noted that a variety of ways to obtain/ensure consent of owners/primary borrowers is contemplated in various implementations of the nested vehicle sharing arrangement described herein. One way is to leverage the driver ratings described previously herein to establish an implied consent arrangement based upon a driver rating threshold specified by an owner of the vehicle. Additionally/alternatively, the vehicle sharing server 145 notifies the owner 710 and/or the primary borrower 700 of the request by the secondary borrower 730. Thereafter, the owner 710 and/or primary borrower 700 negotiate use of the vehicle, during the sub-period of non-use, by the secondary borrower 730. Example systems support “negotiation” messaging between the owner 710, the primary borrower 700 and the secondary borrower 730. Such negotiations include specifying one or more terms of use (e.g. sub-period beginning/end, vehicle pick-up/drop-off location, cost, etc.). After obtaining consent by each affected party to nested vehicle sharing terms (during the sub-period within the period of time during which the vehicle is assigned to the primary borrower 700), the vehicle sharing server 145 commits a nested vehicle sharing reservation to the database and query engine 109 and adjusts related availability information for the shared vehicle currently entrusted to the primary borrower 700.

The secondary borrower 730 thereafter picks up the shared vehicle at the primary location 720 and the sub-period of nested vehicle sharing commences. For example, the secondary borrower 730 uses the shared vehicle for a lunch meeting at a secondary destination 740, the sub-period of nested vehicle sharing spanning from 11 am until 1 pm. During the sub-period of nested vehicle sharing, the vehicle sharing server 145 (or any other suitably configured programmed server machine) generates/acquires a current shared vehicle location, status (i.e., parked, traveling, etc.) and estimated time of arrival (at the designated point of return based upon the current shared vehicle location).

The secondary borrower 730 completes the nested vehicle sharing (preferably within the scheduled sub-period) and returns the shared vehicle to the primary borrower 700 at the primary location 720. Upon completion of the nested vehicle sharing, the vehicle sharing server 145 receives a notification to update the availability information for the shared vehicle for potential further nested vehicle sharing within the period of time the shared vehicle is entrusted to the primary borrower 700. The primary borrower 700 also receives a notification that the shared vehicle has been parked at the agreed return location. Such notification can be provided via instant messaging, email, voicemail, etc. in accordance with notification preferences specified by the primary borrower 700.

At some later point in time (e.g., at the end of the day), the primary borrower 700 returns the shared vehicle to the owner 710 at the location 715—or any other agreed drop-off location, thereby ending a primary sharing period containing a nested vehicle sharing between the primary borrower 700 and the secondary borrower 730.

A variety of ways are contemplated for distributing additional revenue generated by the nested vehicle sharing within a period of use. The revenue generated by permitting the nested vehicle sharing between the primary borrower 700 and the secondary borrower 730 may be distributed to one or more of the accounts of the primary borrower 700 and the owner 710. In one envisioned compensation scheme, the primary borrower 700 receives a discount up front for permitting sharing to occur—without taking into consideration whether the shared vehicle will even be shared with the secondary borrower 730 during the period of time the primary borrower 700 is assigned to the shared vehicle. In another exemplary embodiment, the primary borrower 700 is compensated, with a portion of the actual proceeds from the nested vehicle sharing with the secondary borrower 730. In any event, both the owner 710 and the primary borrower 700 receive some form of economic benefit from potential/actual nested vehicle sharing with the secondary borrower 730 during the sub-period within the period of time of borrowing by the primary borrower 700.

It will thus be appreciated that the described system and method allows for reliable over-the-air submission, via telematics units, of driver and vehicle information relevant to rating such entities and thereafter providing driver and vehicle ratings information by applying specified criteria to the provided driver and vehicle information maintained in a database. Such ratings are used to facilitate applying mutual user and vehicle ratings requirements in response to requests of rated users. It will also be appreciated, however, that the foregoing methods and implementations are merely examples of the inventive principles, and that these illustrate only preferred techniques.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for managing nested sharing of vehicles in a system including a shared vehicle server and a shared vehicle database, the method comprising:
registering in the shared vehicle database, by the shared vehicle server, a primary reservation by a primary borrower for a shared vehicle, the primary reservation specifying a primary time period;
receiving an indication, by the shared vehicle server after the registering, that the shared vehicle is to be made available for nested sharing during a portion of the primary time period;
creating a nested sharing availability record for the shared vehicle, by the shared vehicle server in response to the receiving the indication, the nested sharing availability record specifying a sub-period of the primary time period;
matching, by the shared vehicle server after the creating, the nested sharing availability record to a shared vehicle request for a secondary borrower;
registering in the vehicle database, by the shared vehicle server, a secondary reservation by the secondary borrower for the shared vehicle, the secondary reservation specifying a secondary time period within the sub-period; and
tracking, by the shared vehicle server, status of the shared vehicle during the secondary time period, the tracking including rendering a vehicle location.

2. The method of claim 1 further comprising:
calculating, by the shared vehicle server, a range for the shared vehicle during the sub-period, wherein the calculating is based upon traffic information.

3. The method of claim 1 wherein the nested sharing availability record specifies a pickup location for the shared vehicle.

4. The method of claim 1 wherein the nested sharing availability record specifies a vehicle driving rating, the vehicle driving rating specifying a driving rating requirement for borrowers of the shared vehicle.

5. The method of claim 1 wherein the nested sharing availability record specifies a vehicle sharing rating, the vehicle sharing rating specifying a sharing timeliness requirement for borrowers of the shared vehicle.

6. The method of claim 1 further comprising:
issuing to the primary borrower, by the shared vehicle server after the matching, a proposed nested vehicle use offer for a nested use by the secondary borrower.

7. The method of claim 6 further comprising:
receiving, by the shared vehicle server after the issuing to the primary borrower the proposed nested vehicle user offer, a response to the proposed nested vehicle use offer.

8. The method of claim 7 wherein the response comprises a modified proposed nested vehicle use record that contains a modification to the proposed nested vehicle use record.

9. The method of claim 7 further comprising:
issuing to the secondary borrower, by the shared vehicle server after the receiving the response to the proposed nested vehicle user offer, a notification of the registering in the vehicle database the secondary reservation.

10. The method of claim 1, further comprising:
applying, by the shared vehicle server, tracking information received during the tracking to terms of use of the shared vehicle by the secondary borrower during the secondary time period.

11. The method of claim 1, further comprising:
applying, by the shared vehicle server, tracking information received during the tracking to an agreed return location to render an estimated time of return of the vehicle to the agreed return location.

12. The method of claim 11, further comprising:
issuing an alert, by the shared vehicle server, in response to the applying tracking information.

13. A non-transitory computer-readable medium including computer-executable instructions for managing nested sharing of vehicles in a system including a shared vehicle server and a shared vehicle database, the computer-executable instructions facilitating carrying out, by a shared vehicle server, a method comprising:
registering in the shared vehicle database, by the shared vehicle server, a primary reservation by a primary borrower for a shared vehicle, the primary reservation specifying a primary time period;
receiving an indication, by the shared vehicle server after the registering, that the shared vehicle is to be made available for nested sharing during a portion of the primary time period;
creating a nested sharing availability record for the shared vehicle, by the shared vehicle server in response to the receiving the indication, the nested sharing availability record specifying a sub-period of the primary time period;
matching, by the shared vehicle server after the creating, the nested sharing availability record to a shared vehicle request for a secondary borrower;
registering in the vehicle database, by the shared vehicle server, a secondary reservation by the secondary borrower for the shared vehicle, the secondary reservation specifying a secondary time period within the sub-period; and
tracking, by the shared vehicle server, status of the shared vehicle during the secondary time period, the tracking including rendering a vehicle location.

14. The computer-readable medium of claim 13 wherein the nested sharing availability record specifies a pickup location for the shared vehicle.

15. The computer-readable medium of claim 13 wherein the nested sharing availability record specifies a vehicle driving rating, the vehicle driving rating specifying a driving rating requirement for borrowers of the shared vehicle.

16. The computer-readable medium of claim 13 wherein the nested sharing availability record specifies a vehicle sharing rating, the vehicle sharing rating specifying a sharing timeliness requirement for borrowers of the shared vehicle.

17. The computer-readable medium of claim 13, further comprising:
applying, by the shared vehicle server, tracking information received during the tracking to terms of use of the shared vehicle by the secondary borrower during the secondary time period.

18. The computer-readable medium of claim 13, further comprising:
applying, by the shared vehicle server, tracking information received during the tracking to an agreed return location to render an estimated time of return of the vehicle to the agreed return location.

19. The computer-readable medium of claim 18, further comprising:
issuing an alert, by the shared vehicle server, in response to the applying tracking information.

20. A shared vehicle server computer system for managing nested sharing of vehicles in a system including a shared vehicle database, the shared vehicle server computer system comprising:
a non-transitory computer-readable medium including computer-executable instructions; and
a processor configured to execute the computer-executable instructions to carry out a method comprising:
registering in the shared vehicle database, by the shared vehicle server, a primary reservation by a primary borrower for a shared vehicle, the primary reservation specifying a primary time period;
receiving an indication, by the shared vehicle server after the registering, that the shared vehicle is to be made available for nested sharing during a portion of the primary time period;
creating a nested sharing availability record for the shared vehicle, by the shared vehicle server in response to the receiving the indication, the nested sharing availability record specifying a sub-period of the primary time period;
matching, by the shared vehicle server after the creating, the nested sharing availability record to a shared vehicle request for a secondary borrower;
registering in the vehicle database, by the shared vehicle server, a secondary reservation by the secondary borrower for the shared vehicle, the secondary reservation specifying a secondary time period within the sub-period; and
tracking, by the shared vehicle server, status of the shared vehicle during the secondary time period, the tracking including rendering a vehicle location.
